(19) United States
(12) Patent Application Publication
(10) Pub. No.: US 2004/0044818 A1
(43) Pub. Date: Mar. 4, 2004

(54) Data path arrangement

(76) Inventors: Wolfram Drescher, Dresden (DE); Gerhard Fettweis, Dresden (DE)

Correspondence Address: BAKER & BOTTS, 30 ROCKEFELLER PLAZA, NEW YORK, NY, 10112

(21) Appl. No.: 10/399,243

(22) PCT Filed: Oct. 15, 2001
(86) PCT No.: PCT/DE01/03915

(30) Foreign Application Priority Data
Oct. 16, 2000 (DE) 100 51 284.4

(51) Int. Cl. G06F 13/14

(52) U.S. Cl. 710/305

(57) ABSTRACT

The invention relates to an arrangement for the configuration of data paths, in which different functional units are connected to a linker unit and arranged within a CPU architecture. The aim of the invention is to permit functional extensions within the CPU architecture without essentially extending the networking complexity between the functional units and the controlling register of the CPU. Said aim is achieved, whereby the linking unit essentially comprises a processor bus arrangement and functional units with dedicated input registers and output registers.

The invention relates to an arrangement of data paths of a CPU architecture wherein an RFU (register file unit) is connected to a linking unit, which in turn stands in connection with a functional unit.

A linking unit of this nature is used to connect different functional units that are arranged within a CPU architecture.

It has proven to be a problem that the amount of interconnection in the linking unit rises sharply when the CPU architecture is expanded, particularly with different functional units.

The object of the invention is to permit functional expansions in the CPU architecture without having to significantly increase or redesign the complexity of interconnection in the linking unit located between the functional units and the controlling registers of the CPU.

The solution in accordance with the invention provides that this linking unit consists of a processor bus arrangement, at least one input register associated with the functional unit, and at least one output register associated with the functional unit. The processor bus arrangement is connected at least indirectly to an input of the input register and at least indirectly to an output of the output register. This buffering on the input and output sides of the functional unit in question makes it possible for the data processing in the functional units to take place independently of changing data contents of the processor bus arrangement which switches rapidly and in a complex manner. Moreover, due to the complexity of the processor bus arrangement, when the data path arrangement is functionally expanded the desired data linking can be accomplished largely without additional effort, e.g. through the use of additional multiplexers.

An important embodiment of the solution in accordance with the invention provides that a bus extender is connected between the processor bus arrangement, the input register and the output register. This takes into account the fact that the data to be processed from the functional units of the CPU structure arise largely simultaneously or in parallel. As a result, the functional units are supplied with data by means of a simplified and separate bus extender.

An advantageous embodiment of the solution in accordance with the invention provides that a first input logic gate is connected between the bus extender and the input register. In an advantageous implementation in this context, simply structured logic, such as multiplexers for half-word processing or operators for barrel shifting or saturation for the purpose of hardware optimization, can be distributed within such an input logic gate.

Another advantageous embodiment of the solution in accordance with the invention provides that a second input logic gate is connected between the input register and an input of the functional unit. This solution preferably links in this structure data that must be recursively processed.

A special embodiment of the solution in accordance with the invention provides that an output logic gate is connected between the functional unit and the output register. Preferably, intermediate results are generated and made available for recursion in this solution.

Another embodiment of the solution in accordance with the invention provides that a first output of the output logic gate is connected to an input of the second input logic gate and that a second output of the output logic gate is connected to the first input logic gate. This solution implements particularly complex networked data processing.

Another special embodiment of the solution in accordance with the invention provides that the first output of the output logic gate is connected to the first input and a second input of the second input logic gate. This solution configures the advantageous distribution outside the data path in question of the data to be processed.

The invention is explained below on the basis of an example embodiment. The drawings show:

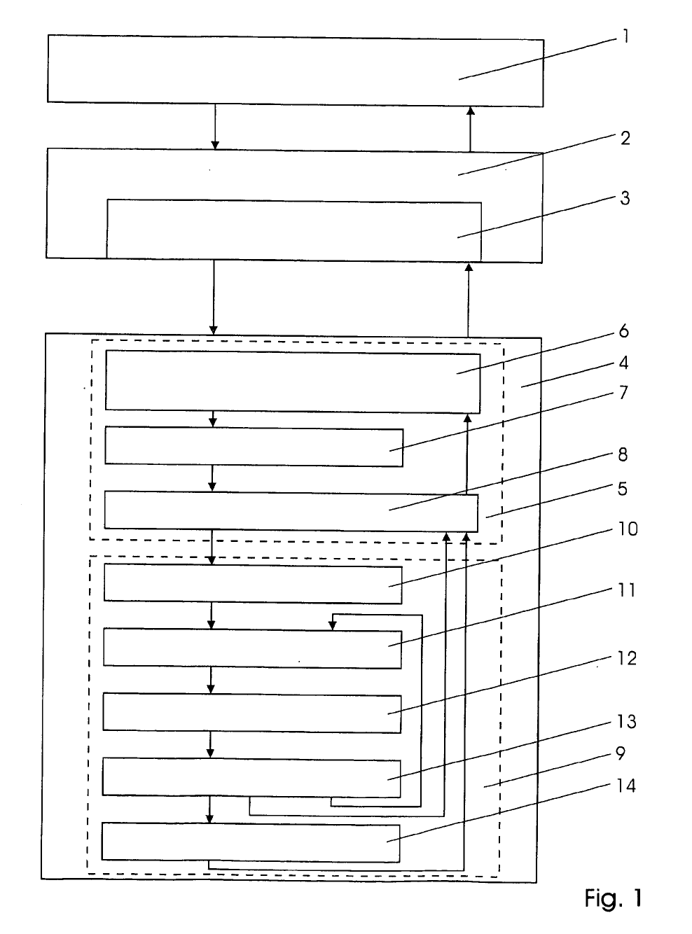

FIG. 1 a block diagram of a slice of data paths,

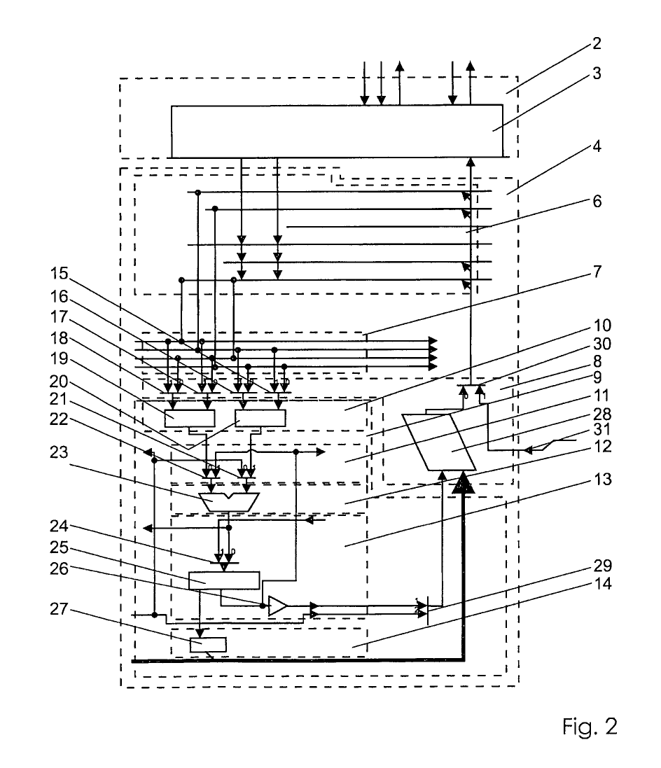

FIG. 2 a signal flow diagram of a data path.

As can be seen in FIG. 1, the MIF 1 exchanges data with the ICU 2. From the RFU 3 located in the ICU 2, the data are transmitted to the processor bus arrangement 6, where they are picked off for the bus extender 7 and arrive at the first input logic gate 8. Here, the data are assigned and then stored in the input register 10. For processing, linking to the existing intermediate results of the output logic gate 13 takes place in the second input logic gate 11. This is followed by processing in the functional unit 12. Linking to output values of adjacent data paths and intermediate storage of the resulting value take place in the connected output logic gate 13. The data from the first output of the output logic gate 13 are applied to an input of the second input logic gate 11. The data from the second output of the output logic gate 13 are supplied to the input of the first input logic gate 8. In addition, the data are provided by the output logic gate 13 to the output register 14. The data are stored there and are transmitted to the connected first input logic gate 8 for transmission. In the latter, the processed data are provided to the processor bus arrangement 6.

FIG. 2 shows the data flow of a data path with its most important processing stages, which implement the blocks shown in FIG. 1 with respect to the individual data path as a component thereof.

The data provided by the RFU 3 are connected to the processor bus arrangement 6. From there, they arrive at the bus extender 7, where they are acquired by each of the multiplexers MUX1 15, MUX2 16, MUX3 17, MUX4 18, which are part of the first input logic gate 8. The data are stored by Register1 19 and Register2 20. The data thus stored are processed in the multiplexers MUX5 21 and MUX6 22. The data are provided for processing in the subsequently connected ALU functional unit 23, and the data are also provided to the adjacent path. Similarly, the data from adjacent paths are linked in MUX5 21 and MUX6 22. Processing of the two operands that are present at the outputs of MUX5 21 and MUX6 22 takes place in the subsequently connected ALU functional unit 23. At the output of the ALU functional unit 23, the output value is linked to a result value from the adjacent data path in accumulator multiplexer 24, and the output value of the ALU functional unit 23 is simultaneously branched off to an additional adjacent data path. Hence, the output value of the accumulator multiplexer 24 is subsequently stored temporarily in the RAA accumulator register 25. The temporarily stored value of the RAA accumulator register 25 is applied to one input of the MUX6 22 and is also made available to the adjacent data path. In addition, this value is supplied through a line driver 26 to the SATMUX 29, which combines it with output data from another data path. Moreover, a temporarily stored value for output storage is stored in the RFA output register 27 for transmission and is delivered through a data bus to the SAT-BSH operator 28. In doing so, the value is processed together with the output data from the SATMUX 29 in the SAT-BSH operator 28. The output data thereof are linked to the extended data path signal 31 in the EXPMUX 30.

The data processed in the data path are transmitted from the output of the EXPMUX 30 to the processor bus arrangement 6 and thus for further processing in the RFU 3 as well.

Data Path Arrangement

List of Reference Numbers

| | |
|---|---|
| 1 | MIF (Memory Interface) |
| 2 | ICU (InterConnecting Unit) |
| 3 | RFU (Register Function Unit) |
| 4 | LCU (Logical Connection Unit) |
| 5 | Linking unit |
| 6 | Processor bus arrangement |
| 7 | Bus extender |
| 8 | First input logic gate |
| 9 | DPX (data path group) |
| 10 | Input register |
| 11 | Second input logic gate |
| 12 | Functional unit |
| 13 | Output logic gate |
| 14 | Output register |
| 15 | MUX1 |
| 16 | MUX2 |
| 17 | MUX3 |
| 18 | MUX4 |
| 19 | Register1 |
| 20 | Register2 |
| 21 | MUX4 |
| 22 | MUX5 |
| 23 | ALU functional unit |
| 24 | Accumulator multiplexer |
| 25 | RAA accumulator register |
| 26 | Line driver |
| 27 | RFA output register |
| 28 | SAT-BSH operator |
| 29 | SATMUX |
| 30 | EXPMUX |
| 31 | Extended data path signal |

1. Arrangement of data paths of a CPU architecture wherein an RFU (register function unit) is connected to a linking unit, which in turn stands in connection with a functional unit, characterized in that this linking unit (5) consists of a processor bus arrangement (6), at least one input register (10) associated with the functional unit (12), and at least one output register (14) associated with the functional unit (12), wherein the processor bus arrangement (5) is connected at least indirectly to an input of the input register (10) and at least indirectly to an output of the output register (14).

2. Arrangement in accordance with claim 1, characterized in that a bus extender (7) is connected between the processor bus arrangement (5) and the input register (10) and the output register (14).

3. Arrangement in accordance with claim 2, characterized in that a first input logic gate (8) is connected between the bus extender (7) and the input register (10).

4. Arrangement in accordance with claim 2, characterized in that a second input logic gate (11) is connected between the input register (10) and an input of the functional unit (12).

5. Arrangement in accordance with claim 2, characterized in that an output logic gate (13) is connected between the functional unit (12) and the output register (14).

6. Arrangement in accordance with claim 2, characterized in that a first output of the output logic gate (13) is connected to an input of the second input logic gate (11) and in that a second output of the output logic gate (13) is connected to the first input logic gate (8).

7. Arrangement in accordance with claim 6, characterized in that the first output of the output logic gate (13) is connected to the first input and a second input of the second input logic gate (11).
